(19) United States
(12) Patent Application Publication
(10) Pub. No.: US 2011/0285159 A1
(43) Pub. Date: Nov. 24, 2011

(54) HAND HELD SCOOP

(76) Inventor: Gary Workman, Lombard, IL (US)

(21) Appl. No.: 12/853,447

(22) Filed: Aug. 10, 2010

Related U.S. Application Data
(63) Continuation-in-part of application No. 12/782,013, filed on May 18, 2010.

(51) Int. Cl. A47F 13/08; A01B 1/02

(52) U.S. Cl. 294/178

(57) ABSTRACT

A one-piece plastic hand held scoop comprises a receptacle formed by an elongate peripheral wall closed at a rear end by a rear wall and open at a front end to define a product holding space. The front end defines a rounded opening. A first handle is connected to the elongate peripheral wall proximate the front end. A second handle is connected to the elongate peripheral wall proximate the rear end.

### CROSS REFERENCE TO RELATED APPLICATIONS

This application is a continuation-in-part of application Ser. No. 12/782,013 filed May 18, 2010.

### FIELD OF THE INVENTION

This invention relates to a hand held scoop and, more particularly, to a scoop unitarily formed of one-piece plastic construction.

### BACKGROUND OF THE INVENTION

A scoop, in one form, comprises a hand held implement used for digging, dipping or shoveling. These may be used, for example, in the construction industry for scooping grout or similar materials. For example, the scoop may be used like a shovel to retrieve grout from a wheelbarrow, or the like, and pour the grout into concrete masonry units, also known as cinder blocks.

Depending on the intended usage, the typical scoop includes one or more handles as required for the typical application. Known scoops used for handling grout use two spaced apart transverse handles. This results in a construction which is not ergonomically correct. This can make it more difficult to handle the product.

Also, typical known scoops are fabricated from multiple parts. This creates problems of breakage, loose or missing parts, and possibilities for poor assembly. The use of multiple parts can also increase manufacturing costs.

The present invention is directed to solving one or more of the problems discussed above, in a novel and simple manner.

### SUMMARY OF THE INVENTION

In accordance with the invention, there is provided a hand held scoop adapted to be ergonomically designed and of unitary construction.

Broadly, in accordance with one aspect of the invention, there is disclosed a hand held scoop comprising a receptacle formed by an elongate peripheral wall closed at a rear end by a rear wall and open at a front end to define a product holding space. The front end defines a rounded opening. A first handle is connected to the elongate peripheral wall proximate the front end. A second handle is connected to the elongate peripheral wall proximate the rear end.

There is disclosed in accordance with another aspect of the invention a one-piece plastic hand held scoop comprising a receptacle formed by an elongate peripheral wall closed at a rear end by a rear wall and open at a front end to define a product holding space. The elongate peripheral wall has a generally rectangular cross section at the product holding space that narrows to a generally oval cross section at the open front end. A first handle is connected to the elongate peripheral wall proximate the front end. A second handle is connected to the elongate peripheral wall rearward of the first handle. The hand held scoop is unitarily formed of one piece plastic construction.

It is a feature of the invention that the peripheral wall includes a plurality of elongate planar wall segments connected at angled bends, the angled bends tapering proximate the front end to define the rounded opening.

It is another feature of the invention that the first and second handles comprise hollow handles opening into the product holding space. The first and second handles may be U-shaped.

It is still another feature of the invention that the elongate peripheral wall comprises a top wall and a bottom wall connected by opposite side walls.

It is a further feature of the invention that the bottom wall is longer than the top wall and a front edge of the side walls is angled downwardly from a front edge of the top wall. The bottom wall may be sloped downwardly from the side walls to a center line. A front edge of the bottom wall may be angled downwardly. The bottom wall may comprise a generally planar elongate center section connected between opposite angled wall sections to the side walls.

Further features and advantages of the invention will be readily apparent from the specification and from the drawings.

### BRIEF DESCRIPTION OF THE DRAWINGS

FIG. 1 is a perspective view of a hand held scoop in accordance with a first embodiment of the invention;

FIG. 2 is a side elevation view of the hand held scoop of FIG. 1;

FIG. 3 is a top plan view of the hand held scoop of FIG. 1;

FIG. 4 is a rear elevation view of the hand held scoop of FIG. 1;

FIG. 5 is a front elevation view of the hand held scoop of FIG. 1;

FIG. 6 is a sectional view taken along the line 6-6 of FIG. 5;

FIG. 7 is a sectional view taken along the line 7-7 of FIG. 2;

FIG. 8 is a sectional view taken along the line 8-8 of FIG. 2;

FIG. 9 is a detailed view of a cross-section of the handle taken from FIG. 6;

FIG. 10 is a perspective view of a hand held scoop in accordance with a second embodiment of the invention;

FIG. 11 is a side elevation view of the hand held scoop of FIG. 10;

FIG. 12 is a sectional view taken along the line 12-12 of FIG. 11;

FIG. 13 is a sectional view taken along the line 13-13 of FIG. 11;

FIG. 14 is a perspective view of a hand held scoop in accordance with a third embodiment of the invention;

FIG. 15 is a perspective view of a hand held scoop in accordance with a fourth embodiment of the invention;

FIG. 16 is a front elevation view of the hand held scoop of FIG. 15;

FIG. 17 is a top plan view of the hand held scoop of FIG. 15;

FIG. 18 is a perspective view of a hand held scoop in accordance with a fifth embodiment of the invention;

FIG. 19 is a top plan view of the hand held scoop of FIG. 18;

FIG. 20 is a side elevation view of the hand held scoop of FIG. 18; and

FIG. 21 is a front elevation view of the hand held scoop of FIG. 18.

### DETAILED DESCRIPTION OF THE DRAWINGS

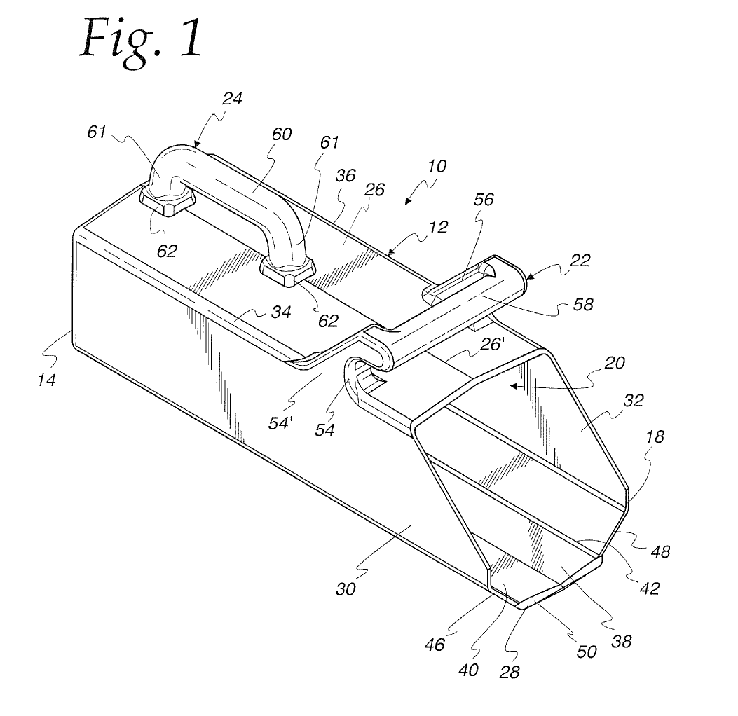

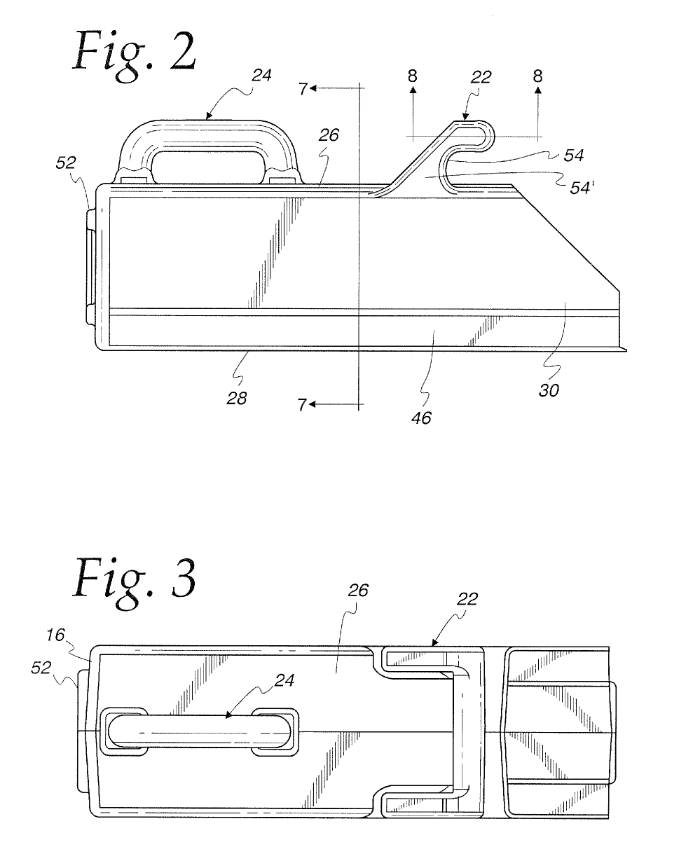

Referring initially to FIG. 1, a hand held scoop 10 in accordance with a first embodiment of the invention is illustrated. The hand held scoop 10 is unitarily formed of one-piece plastic construction. Particularly, the scoop 10 may be formed by rotational molding using either high density or low density polyethylene. The wall thickness is generally uniform and may be on the order of 0.150″ throughout, it being understood that wall thickness may be greater at joints or the like to provide reinforcement, as described below.

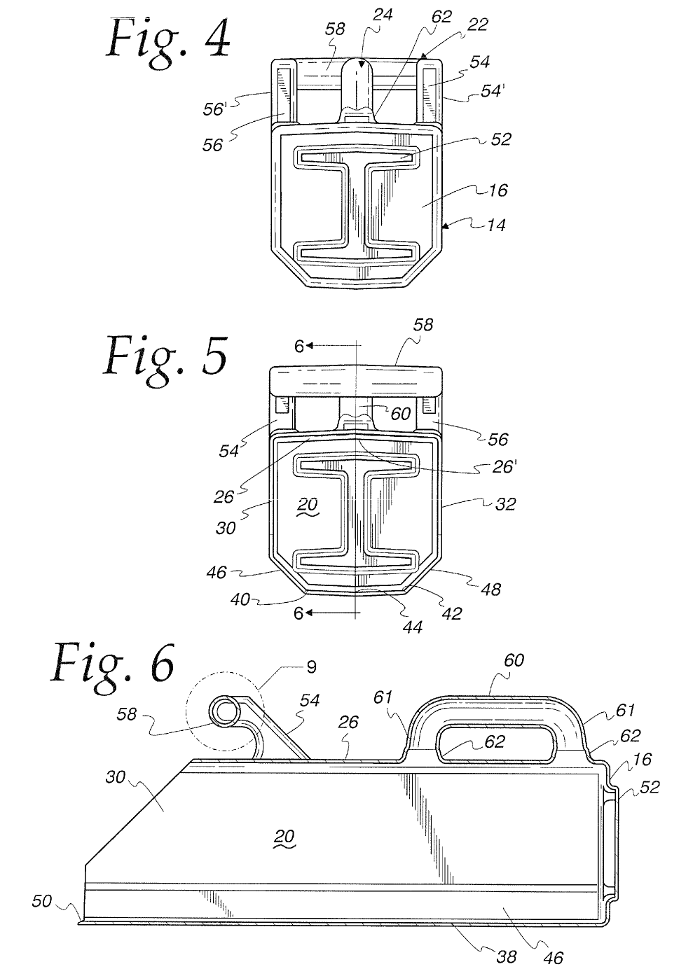

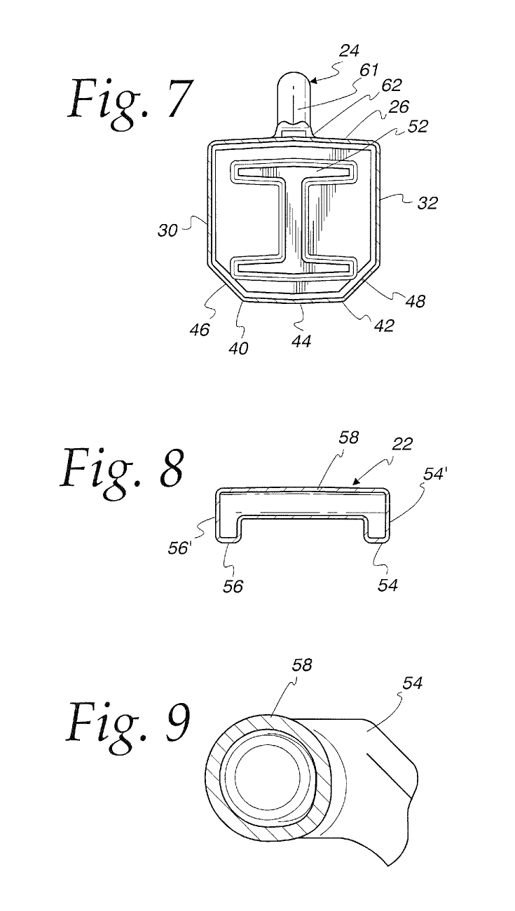

The scoop 10 comprises an elongate peripheral wall 12 closed at a rear end 14 by a rear wall 16, see FIG. 4, and open at a front end 18 to define a product holding space 20. As used herein, the word “front” is used relative to the open end of the product holding space 20 while the word “rear” is relative to the closed end of the product holding space 20. Owing to the peripheral wall 12 being longer from the rear 14 to the front 18 this direction is referred to herein as longitudinal, and across the peripheral wall 12 as transverse.

A first handle 22 is connected to and extends transverse to the elongate peripheral wall 12 proximate the front end 18. A second handle 24 is connected to the elongate peripheral wall 12 rearward of the first handle 22 and extends longitudinally relative to the elongate peripheral wall 12.

The elongate peripheral wall 12 comprises a top wall 26 and a bottom wall 28 connected between opposite side walls 30 and 32. The top wall 26 is generally planar except that it slopes slightly downward from a center line 26′ outwardly to the side walls 30 and 32, as shown in FIGS. 1 and 5. The top wall 26 is connected to the side walls 30 and 32 at rounded edges 34 and 36, respectively.

The bottom wall 28 comprises a center section 38 which is generally planar except that it slopes slightly downward from outer edges 40 and 42 to a center line 44. Opposite angled wall sections 46 and 48 are connected between the respective center section outer edges 40 and 42 and the respective opposite side walls 30 and 32. This slope aids in complete removal of product from the holding space 20. The bottom wall center section 38 includes a front edge 50 which is angled downwardly to aid in shoveling product.

In accordance with the invention, the top wall 26, side walls 30 and 32, the bottom wall center section 38 and the opposite angled wall sections 46 and 48 comprise elongate planar wall segments connected at angled bends of the peripheral wall 12. For example, the top wall 26 is connected to the side walls 30 and 32 at angled bends corresponding to the edges 34 and 36, respectively. This structure results in the product holding space 20 being generally rectangular in cross section, as shown in FIG. 5. However, the angled wall sections 46 and 48 provide beveled lower corners with this generally rectangular cross-sectional construction. As is apparent, the beveling at the corners could be eliminated.

A support foot 52 extends rearwardly from the rear wall 16, see FIG. 4. The support foot 52 is in the shape of an “I” and is of a size corresponding to size of the rear wall 16. The support foot 52 provides reinforcement and a planar surface so that the scoop 10 can be supported on a horizontal support surface, much like a bucket, with the support foot 52 resting on the support surface and the front end 18 facing upwardly. Thus, the scoop 10 can stand on its end and not lose material, which could occur if it rests on the bottom wall 28 in the orientation shown in FIG. 1

The first handle 22 is generally U-shaped (see FIG. 5) and includes a first leg 54 and an opposite second leg 56 connected to a hand gripping cross piece in the form of a cylindrical body 58. The legs 54 and 56 are rectangular in cross section. Outside surfaces 54′ and 56′ of the respective legs 54 and 56 are flush with the respective side walls 30 and 32. The legs 54 and 56 are integrally formed with the top wall 26 and are wider at the joint with the top wall 26. The legs 54 and 56 are angled upwardly and frontwardly to position the cylindrical body 58 closer to the front end 18. The first handle 22 is hollow and opens into the product holding space 20.

The second handle 24 is U-shaped (see FIG. 6) and includes a hand gripping cross piece in the form of a cylindrical body 60 between opposite legs 61. The body 60 and the legs 61 are circular in cross section to define a tubular handle which is hollow and opens into the product holding space 20, as shown. A wider reinforcement collar 62 surrounds each end of the legs 61 where they are joined to the top wall 26.

In an illustrative embodiment of the invention, the scoop 10 is approximately 21″ in length. The bottom wall 38 extends substantially the full length of the scoop 10. The top wall 26 is shorter and is on the order of 16″ in length. Front edges of the side walls 30 and 32 are angled downwardly from a front edge of the top wall 26 to a front edge of the bottom wall 38. The angled front end along with the bottom wall center section front edge 50 being angled downwardly aids in scooping products, particularly from the bottom of a wheelbarrow or the like where the scoop can scrape along to lift as much material as possible. The provision of the first handle 22 extending transversely, while the second handle 24 extends longitudinally, provides an ergonomically correct configuration which can be quite helpful when scooping heavy materials, such as grout or gravel or the like. The use of a one piece molded unit eliminates problems of breakage or parts becoming separated with multiple part construction, and avoid concern with missing parts. The resulting product is relatively inexpensive to produce and is light weight. Moreover, being of all plastic construction, rust of metal parts is not a problem and a more durable construction results.

Described below are hand held scoops in accordance with alternative embodiments of the invention each including a rounded front opening. Each hand held scoop is unitarily formed of one-piece plastic construction. Particularly, the scoops may be formed by rotational molding using either high density or low density polyethylene. The wall thickness is generally uniform and may be on the order of 0.150″ throughout, it being understood that wall thickness may be greater at joints or the like to provide reinforcement, as described below.

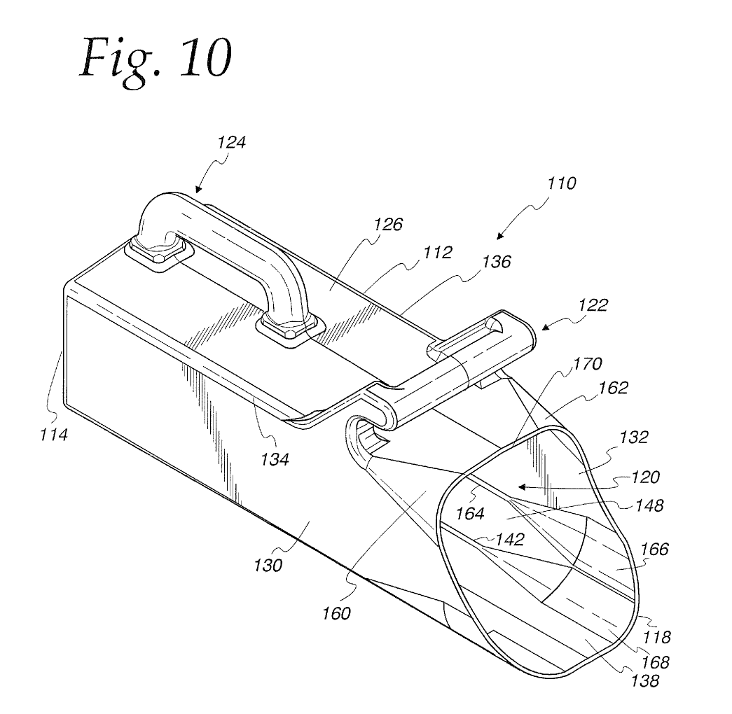

FIG. 10 illustrates a hand held scoop 110 in accordance with a second embodiment of the invention. The hand held scoop 110 differs from the hand held scoop 10, see FIG. 1, primarily in the fact that the peripheral wall narrows proximate the front end corners to provide a more rounded or generally oval-like front opening, as described particularly below.

To the extent elements of the hand held scoop 110 are similar to elements of the hand held scoop 10, they are described with similar reference numerals preceded by the prefix numeral 1. For example, the first handle 122 corresponds to the handle 22 shown in FIG. 1. In such instances, additional description may not be provided below as reference may be made to the prior description. Any differences will primarily be discussed in detail below. This numbering will also apply to additional embodiments discussed further below, except with a different prefix number.

The scoop 110 comprises an elongate peripheral wall 112 closed at a rear end 114 by a rear wall 116 and open at a front end 118 to define a product holding space 120. A first handle 122 is connected to and extends transverse to the elongate peripheral wall 112 proximate the front end 118. A second handle 124 is connected to the elongate peripheral wall 112 rearward of the first handle 122 and extends longitudinally relative to the elongate peripheral wall 112. The elongate peripheral wall 112 comprises a top wall 126 and a bottom wall 128 connected between opposite side walls 130 and 132. The top wall 126 is connected to the side walls 130 and 132 at rounded edges 134 and 136, respectively. The bottom wall 128 comprises a center section 138 which is generally planar except that it slopes slightly downward from outer edges 140 and 142. Opposite angled wall sections 146 and 148 are connected between the respective center section outer edges 140 and 142 and the respective opposite side walls 130 and 132. This slope aids in complete removal of product from the holding space 120. The bottom wall center section 138 includes a front edge 150 which is angled downwardly to aid in shoveling product.

The peripheral side wall 112 includes angled bends between the elongate planar wall segments, as discussed above. In accordance with the invention, each of the angled bends is tapered inwardly proximate the front end 118 to provided the rounded opening. For example, the angled bend 134 tapers at 160 proximate the front end 118 so that it is rounded and having a radius R1, see FIG. 13, of approximately 1.85″. Similar taping is provided at 162 at the opposite side angled bend 136. At the bottom, an angled bend 164 between the side wall 132 and angled wall section 148 is tapered at 166 proximate the front end 118. Likewise, the angled bend at 142 between the bottom section 138 and angled wall section 148 is tapered as at 168. The tapered sections 166 and 168 are merged together provide a radius R2 of about 2.25″ as shown particularly in FIG. 12.

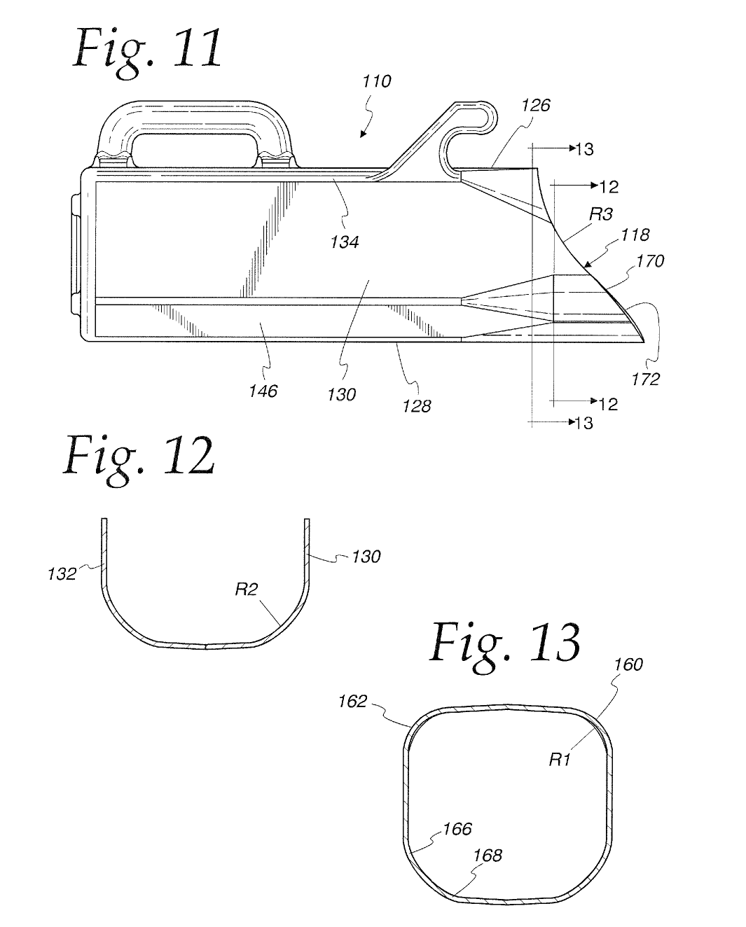

The front end 118 of the hand held scoop 110 is defined by a front edge 170. The front edge, looking from the side, as shown in FIG. 11, has a contour extending downwardly from the top wall 126 to the bottom wall 128. Particularly, the front edge towards the top has a curvature with a radius R3 of about 6″ and then straightens out proximate a bottom portion 172 having an angle of about 49° relative to the bottom wall 128.

In accordance with this second embodiment of the invention, the product holding space 120 is generally rectangular throughout, in cross section, with beveled lower corners, as with the embodiment of FIG. 1, and is rounded or oval shaped at the front end 118. This curvature enhances moldability of the scoop 110 and results in it being visually more appealing. The curvature also softens corners to lessen cracking and/or breakage. The use of the larger, rectangular or box like holding space provides greater volume compared to a round or oval space and the shape provides for smaller and tighter packaging for storing, and shipping of the hand held scoop 110.

The hand held scoop 110 has an overall length of about 21½″, with the top being about 17½″. The first handle 122 is spaced from the front edge 170 about 1.5″.

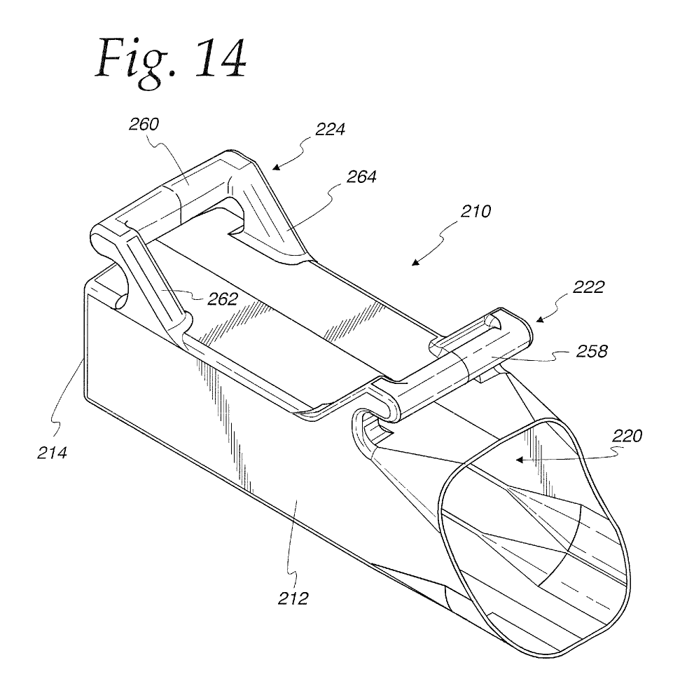

Referring to FIG. 14, a hand held scoop 210 in accordance with a third embodiment of the invention is illustrated. The hand held scoop 210 is substantially identical to the hand held scoop 110, see FIG. 10, except for the orientation of a second handle 224. The second handle 224 is parallel to a first handle 222. Particularly, the second handle 224 is substantially identical to the first handle 222 except that it is a mirror image thereof.

The hand held scoop 210 includes a peripheral side wall 212 which is identical to the peripheral side wall 112, see FIG. 10. The second handle 224 is connected to the elongate peripheral wall 212 rearward of the first handle 222 and extends transversely relative to the elongate peripheral wall 212. The second handle 224 is generally U-shaped and includes a hand gripping cross piece in the form of a cylindrical body 260 connected between opposite legs 262 and 264. Outside surfaces of the legs 262 and 264 are flush with side walls of the peripheral side wall 212, as with the first handle 222 and the corresponding handle 22 of the embodiment of FIG. 1. The legs 262 and 264 are angled upwardly and rearwardly to position the cylindrical body 260 proximate a rear end 214. The second handle 224 is hollow and opens into the product holding space 220.

In accordance with the invention, center lines of a cross piece 258 of the first handle 222 and the second handle cross piece 260 are about 14″ apart. This spacing positions the handles 222 and 224 approximately shoulder width apart so that they are directly over the feet of an average person to provide ease of movement such as when carrying the hand held scoop 210.

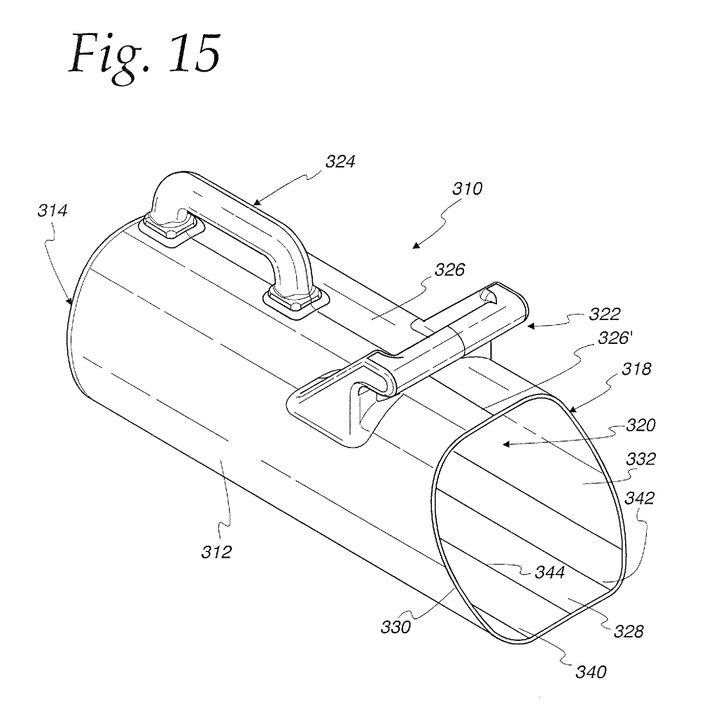

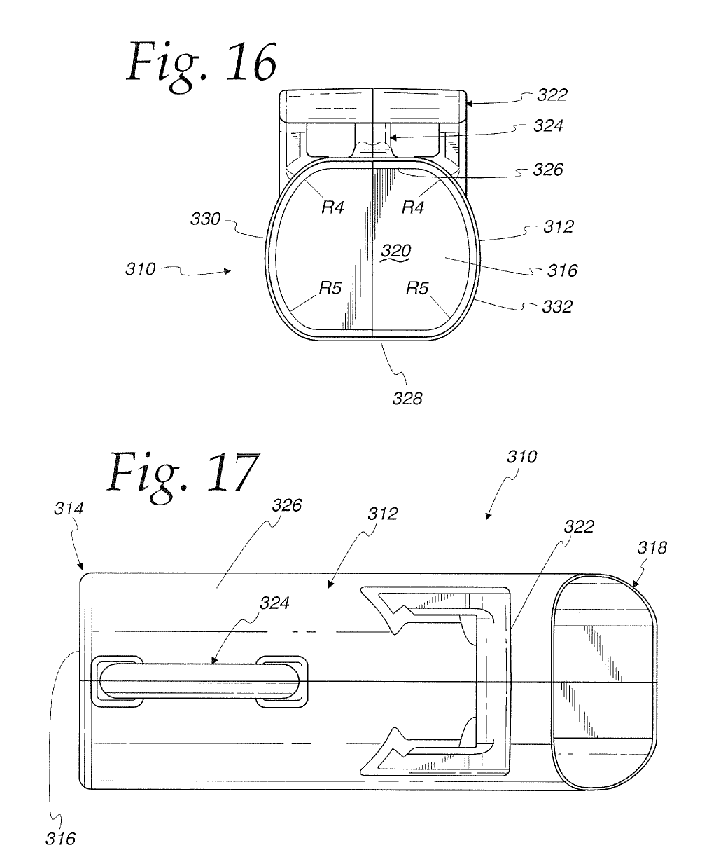

Referring to FIG. 15, a hand held scoop 310 in accordance with a fourth embodiment of the invention is illustrated. The hand held scoop 310 is unitarily formed of one-piece plastic construction, as with the other embodiments above. The hand held scoop 310 comprises an elongate peripheral wall 312 closed at a rear end 314 by a rear wall 316, see FIG. 16, and open at a front end 318 to define a product holding space 320. The hand held scoop 310 includes a first handle 322 and a second handle 324 similar to the respective handles 22 and 24 discussed above relative to FIG. 1.

The elongate peripheral wall 312 comprises a top wall 326 and a bottom wall 328 connected between opposite side walls 330 and 332. The top wall 326 is generally planar except that it slopes slightly downward from a center line 326′ outwardly to the side walls 330 and 332. The bottom wall is generally planar except that slopes downward from outer edges 340 and 342 at a center line 344. The side walls 330 and 332 are rounded having a radius R4 of about 2″ at a top portion and a radius R5 of about 1.5″ at a bottom portion, as illustrated in FIG. 16. Owing to this construction, the product holding space 320 is generally oval shaped throughout, albeit flattened at the top and bottom, as shown, and wider at the bottom.

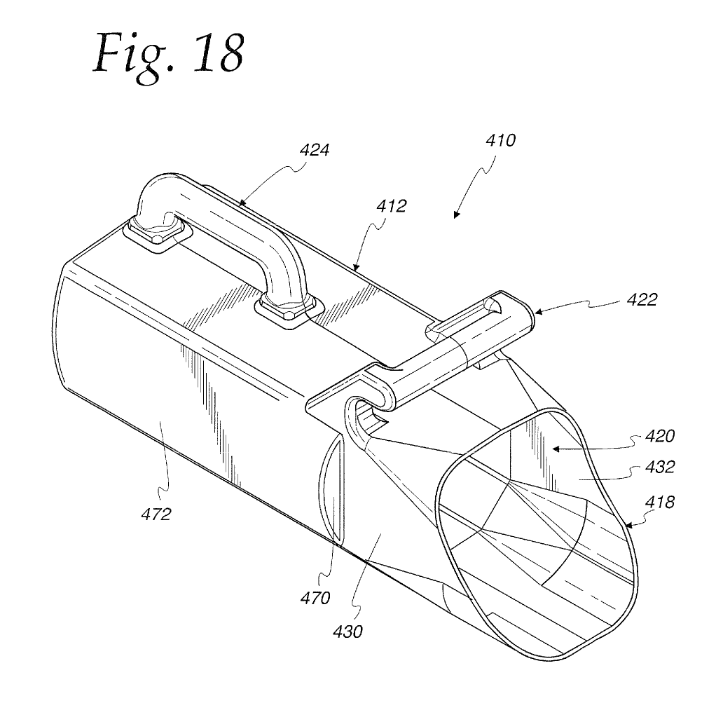

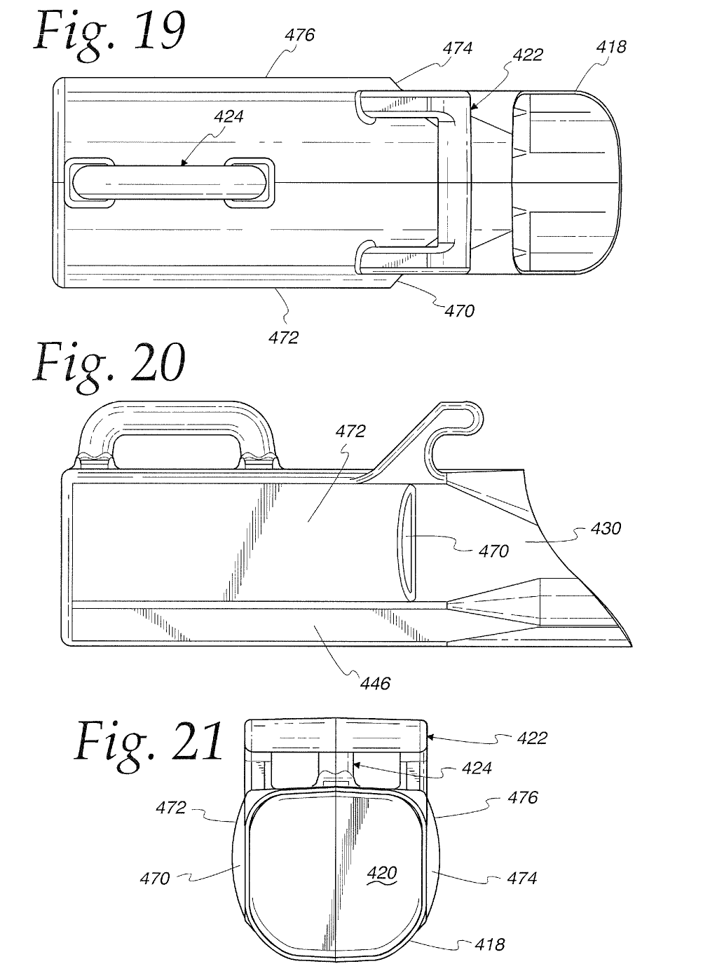

With reference to FIG. 18, a hand held scoop 410 in accordance with a fifth embodiment of the invention is illustrated. The hand held scoop 410 is unitarily formed of one-piece plastic construction. The scoop 410 comprises an elongate peripheral wall 412. The hand held scoop 410 is generally similar to the hand held scoop 110, see FIG. 10, except that side walls 430 and 432 are planar proximate a front end 418 and are bumped out at a curved wall section 470 just below the first handle 422 to provide a curved side wall section 472. The opposite side wall 432 is generally similar including a bumped out portion 474 to a curved wall portion 476, as shown in FIG. 19. The use of these curved side wall portions 472 and 476 provide for a “bowed out” side wall, to increase the capacity of the product holding space 420 compared to the second embodiment 110, see FIG. 10. The curved wall sections 472 and 476 have a radius of about 5¼″. This results in an overall width of about 7.75″ for the hand held scoop 410, compared to a width of about 6.75″ for the hand held scoop 110 of FIG. 10. Thus, each curved wall section 472 and 476 bows out about ½″.

Thus, in accordance with the invention, a plurality of designs for a hand held scoop are each unitarily formed of one-piece plastic construction and selectively include a more box like structure, a more rounded structure and various combinations of the two to provide for different storage volume and appearances. As will be apparent, the specific shape of any of the elongate peripheral wall, as well as dimensions, may be different from those disclosed herein.

I claim:

1. A hand-held scoop comprising:
a receptacle formed by an elongate peripheral wall closed at a rear end by a rear wall and open at a front end to define a product holding space, wherein the front end defines a rounded opening;
a first handle connected to the elongate peripheral wall proximate the front end; and
a second handle connected to the elongate peripheral wall proximate the rear end.

2. The hand-held scoop of claim 1 wherein the peripheral wall includes a plurality of elongate planar wall segments connected at angled bends, the angled bends tapering proximate the front end to define the rounded opening.

3. The hand-held scoop of claim 1 wherein the first and second handles comprise hollow handles opening into the product holding space.

4. The hand-held scoop of claim 3 wherein the first and second handles are U-shaped.

5. The hand-held scoop of claim 1 wherein the first handle extends transverse to the elongate peripheral wall proximate the front end and the second handle extends longitudinally relative to the elongate peripheral wall.

6. The hand-held scoop of claim 1 wherein a bottom wall segment of the peripheral wall is longer than a top wall segment and a front edge of the peripheral wall angles downwardly from a front edge of the top wall.

7. The hand-held scoop of claim 6 wherein side edges of the front edge are curved.

8. The hand-held scoop of claim 5 wherein a front edge of the bottom wall is angled downwardly.

9. The hand-held scoop of claim 2 wherein the bottom wall segment comprises a generally planar elongate center section connected between opposite angled wall sections to side walls.

10. The hand-held scoop of claim 1 wherein the hand-held scoop is unitarily formed of one-piece plastic construction.

11. A one-piece plastic hand-held scoop comprising:
a receptacle formed by an elongate peripheral wall closed at a rear end by a rear wall and open at a front end to define a product holding space, the elongate peripheral wall having a generally rectangular cross section at the product holding space that narrows to a generally oval cross section at the open front end;
a first handle connected to the elongate peripheral wall proximate the front end; and
a second handle connected to the elongate peripheral wall rearward of the first handle,
wherein the hand-held scoop is unitarily formed of one-piece plastic construction.

12. The hand-held scoop of claim 11 further comprising support feet extending rearward form the rear wall.

13. The hand-held scoop of claim 11 wherein the first and second handles comprise hollow handles opening into the product holding space.

14. The hand-held scoop of claim 13 wherein the first and second handles are U-shaped.

15. The hand-held scoop of claim 11 wherein the elongate peripheral wall comprises a top wall and a bottom wall connected by opposite side walls.

16. The hand-held scoop of claim 15 wherein the bottom wall is longer than the top wall and a front edge of the side walls angle downwardly from a front edge of the top wall.

17. The hand-held scoop of claim 15 wherein a portion of the side walls are bowed outwardly.

18. The hand-held scoop of claim 17 wherein the bowed side wall portions comprise curved side wall portions.

19. The hand-held scoop of claim 15 wherein the bottom wall comprises a generally planar elongate center section connected between opposite angled wall sections to the side walls.

20. The hand-held scoop of claim 11 wherein the first handle extends transverse to the elongate peripheral wall and the second handle extends longitudinally to the elongate peripheral wall.
